(19) United States
(12) Patent Application Publication
(10) Pub. No.: US 2014/0180771 A1
(43) Pub. Date: Jun. 26, 2014

(54) Teacher Observation and Evaluation System for Mobile Devices

(71) Applicant: R & A Solutions, Inc., Franklin, TN (US)

(72) Inventors: Martin Patrick Reed, Franklin, TN (US); Michael James McFarren, Spring Hill, TN (US); Armando de Oliveira Fortuna, Franklin, TN (US); James Edward Reams, Nashville, TN (US)

(73) Assignee: R & A Solutions, Inc., Franklin, TN (US)

(21) Appl. No.: 14/032,177

(22) Filed: Sep. 19, 2013

Related U.S. Application Data
(63) Continuation-in-part of application No. 13/364,999, filed on Feb. 2, 2012, now abandoned.

(51) Int. Cl. G06Q 50/20; G06Q 10/06

(52) U.S. Cl. CPC G06Q 50/20; G06Q 10/06398
USPC 705/7.42

(57) ABSTRACT

A teacher observation and evaluation system and method for mobile devices is provided, comprising providing a data server for storing and delivering selected information, including teacher data, rubrics, and other educational data; providing an administration server connected to the data server for controlling access by users; providing one or more wireless mobile devices connected to the data server via a wireless connection, wherein each mobile device includes an observation and evaluation rubric; observing a teacher in a classroom setting and inputting into the mobile device observation and evaluation data related to the teacher's performance; synchronizing the observation and evaluation data with the data server; and reporting the observation and evaluation data to selected administrative personnel.

### CROSS-REFERENCE TO RELATED APPLICATIONS

This continuation-in-part application claims the benefit of U.S. application Ser. No. 13/364,999, filed on Feb. 2, 2012, which claims the benefit of provisional Application Ser. No. 61/438,789, filed on Feb. 2, 2011.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON COMPACT DISC

Not applicable.

### BACKGROUND OF THE INVENTION

1. Field of the Invention

The present invention relates to systems and methods for designing and administering teacher observation and evaluation systems, and more particularly to such systems and methods enabled for use on computers or mobile wireless devices.

2. Description of Related Art

In the education field, schools and school districts have a continuing need to reliably assess the performance of teachers. Many school districts are required by law to evaluate the performance of their teachers on a regular basis, and to establish that all teachers are compliant with guidelines and educational goals established by the districts. Such evaluations may be conducted by school principals, district administrative officials, or consultants. However, standards for review and evaluation will often differ between districts and schools, and there remains a great need for systems which afford flexibility to educational professionals to assess performance in a manner that is both effective and also suited to the particular school or educational environment.

Various systems and methods have attempted to provide viable solutions to these problems, but still fail to offer a robust and flexible package of tools which accounts for the needs of all stakeholders in the process, including administrators, principals, observers, and teachers. One such attempt is disclosed in U.S. Publication 2006/0173731 to Scarpelli, which describes a method and apparatus for personnel evaluation. Generally, the Scarpelli system provides calendaring functionality for observations, establishes rubrics for assessing performance criteria for teachers, and enables reporting of results to those persons requiring such information. However, notably lacking from Scarpelli are the ability to: (1) map scripting blocks (or comments made by an observer during an observation visit to a teacher) to specific indicators which are part of the rubric; and (2) recommend and implement specific training objectives (such as professional development courses) which are directed toward correcting deficiencies in the teacher's performance. Moreover, any evaluation system must also enable observations to be easily conducted using mobile wireless device which may be synchronized with an administrative server during or after the observation.

What is needed, therefore, is an automated system for observation and evaluation of teachers which provides consistency, transparency and flexibility to administrators, fully accommodates the specific preferences of schools and school districts, and which includes rubric-agnostic tools that allow educators to make decisions about reporting and remedial measures.

### SUMMARY OF THE INVENTION

A teacher observation and evaluation system and method for mobile devices is provided, comprising: providing a data server for storing and delivering selected information, including teacher data, rubrics, and other educational data; providing an administration server connected to the data server for controlling access by users; providing one or more wireless mobile devices connected to the data server via a wireless connection, wherein each mobile device includes at least one, but in most instances a plurality of, observation and evaluation rubrics; observing a teacher in a classroom setting and inputting into the mobile device observation and evaluation data related to the teacher's performance; synchronizing the observation and evaluation data with the data server; and reporting the observation and evaluation data to selected administrative personnel.

The mobile devices will be assigned to users who will begin an observation or evaluation by opening the application. While observing a teacher, usually in a live classroom, lecture hall, or other educational setting, the user will input scores, level assignments, notes, observations, or evaluation data in the appropriate fields to coincide with the standards, strands, indicators, or domains presented by the rubric in use.

The mobile devices can be used by multiple users to evaluate a large quantity of educators by the use of a role-based permissions system that gives users individual sign-in credentials. Users will have access to their own individual assignments and work flow schedules on the mobile device, in addition to the ability to input observation and evaluation data from the classroom, lecture hall, workshop, or other observation area.

Data will be transferred to and from the mobile device by synchronizing (syncing) to an online data warehouse. Upon initial receipt of the mobile device, the user will sync with the data warehouse to download his/her assignments, schedules, rubrics, and other relevant information. Upon the completion of the observation and evaluation assignments, the user will sync the mobile device again, uploading the scores, notes, and other results to the data warehouse. This data will then be available for analysis and reporting by the proper administrative or education parties, which may include the observer or evaluator. During an observation and evaluation program period, syncing of the device may result in both downloading and uploading of data.

Users will be able to save observations or evaluations in progress and return to them later. Users can also start an observation or collection of data for one educator, exit that observation, and the system will automatically save the information collected. Users can start another observation for a different or the same educator without losing data from prior observations. Also, multiple rubrics may be applied to multiple educators, and those multiple observations can be open at the same time and completed any time the observer chooses.

Administrators will have the option to allow for completion of in-progress observations and evaluations and editing of completed observations and evaluations online through a web interface. They will also have the option to lock an observation as complete, disallowing editing or modification from the mobile device and/or through an online portal.

Reporting will be accomplished through the web interface and will allow quick and paper-free statistical analysis of teacher performance based on data collected on the mobile device, as well as other pertinent education data such as student test scores and demographic information.

In a preferred embodiment, an observation event scheduled on the administration server is transmitted to the mobile device. Users are granted differing access credentials to the system based on predetermined roles of observer, teacher, principal, administration, or other similar roles. Preferably, the mobile device can record observation data without a wireless connection to the administration server.

During an observation, the mobile device enables the user to enter a plurality of scripting blocks related to the observation of a teacher. The rubric includes a plurality of indicators corresponding to performance criteria of the teacher, wherein the mobile device enables the user to enter a plurality of scripting blocks related to the observation of the teacher, and wherein the scripting blocks are mapped to one or more of the indicators by the user.

The mobile device and web-based interface include a display of the indicators, and means for scoring each of the indicators on a predetermined scale. The system further includes a professional development function, wherein predetermined professional development training is offered to a user based on the scoring of the indicators. The scored indicators include a notification of a low score sufficient to trigger a predetermined professional development training requirement. Optionally, the professional development training can be rated by the user.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1 shows an image on a mobile teacher observation and evaluation system requiring initialization credentials.

FIG. 2 shows the initialization of the mobile system is complete.

FIG. 3 shows a login box.

FIG. 4 shows a page enabling the start of an observation and an option for synchronization.

FIG. 5 shows an educator list for selection prior to an observation.

FIG. 6 shows a schedule of educator visits for an observer.

FIG. 7 shows a visit list for a specific educator to be observed.

FIG. 8 shows an option to start a visit not previously scheduled.

FIG. 9 shows a scripting page used during an observation.

FIG. 10 shows a scripting block made during an observation.

FIG. 11 shows multiple scripting blocks recorded during an observation.

FIG. 12 shows an option to save the observation.

FIG. 13 shows a mapping page to map scripting blocks to predefined indicators.

FIG. 14 shows a summary view of the mapping page.

FIG. 15 shows a scripting block being mapped to a specific indicator.

FIG. 16 shows confirmation that a scripting block has been mapped to a specific indicator.

FIG. 17 shows a scripting block being mapped to multiple indicators.

FIG. 18 shows a window identifying which scripting blocks are mapped to a specific indicator.

FIG. 19 shows a scoring page for a specific rubric, with highlighted indicators having mapped scripting blocks.

FIG. 20 shows the scoring page with an option for including notes.

FIG. 21 shows how scores are added to the scoring page along with notes.

FIG. 22 shows a scored indicator for which no scripting blocks have been mapped.

FIG. 23 shows the options for saving the scoring on an observation.

FIG. 24 shows a mobile observation as completed for a specific educator.

FIG. 25 shows an option to wirelessly synchronize the mobile observations to the remote administrator server.

FIG. 26 shows a schematic diagram of the major elements of the TOWER web-based system.

FIG. 27 shows an initial interface or dashboard screen with various options for interacting with the system.

FIG. 28 shows a list of educators whose evaluations can be managed.

FIG. 29 shows an evaluation portfolio for a particular educator.

FIG. 30 shows a scheduling interface corresponding to a specific educator.

FIG. 31 shows an interface for scoring an observation.

FIG. 32 shows an option for finalizing a scored observation.

FIG. 33 shows a finalized observation in read only mode.

FIG. 34 shows a list of educators under the Observation tab.

FIG. 35 shows a filtering field for selection of a specific educator.

FIG. 36 shows a finalized observation having alerts regarding required professional development.

FIG. 37 shows a notification regarding allowing the user to proceed with professional development.

FIG. 38 shows the ability to assign specific professional development coursework to specific indicators based on scores.

FIG. 39 shows a professional development course displayed within the TOWER user interface.

FIG. 40 shows a list of required professional development courses required under the Professional Development tab, along with applicable deadlines for completion.

FIG. 41 shows a professional development status provided under the Dashboard tab.

FIG. 42 shows the user completed professional development courses with a rating system to score the coursework.

FIG. 43 shows a Reports tab having options for review progress and completion, performance, and administration.

FIG. 44 shows report options for a completion summary and observation counts by observer.

FIG. 45 shows report options for scored observations.

FIG. 46 shows report options for administrative tasks related to users, mobile devices, and user login activity.

FIG. 47 shows an interface for managing configuration settings within the TOWER admin server for a user with higher access credentials.

FIG. 48 shows an interface for managing configuration settings within the TOWER admin server for a user with lower access credentials.

FIG. 49 is a flowchart of the TOWER user setup process.

FIG. 50 is a flowchart of the TOWER user accounts process.

FIG. 51 is a flowchart of the TOWER groups editor process.

FIG. 52 is a flowchart of the TOWER user interface process.

FIG. 53 is a flowchart of the TOWER announcement management process.

FIG. 54 is a flowchart of the TOWER observation management process.

FIG. 55 is a flowchart of the TOWER observation scheduling process.

FIG. 56 is a flowchart of the TOWER mobile device setup process.

FIG. 57 is a flowchart of the TOWER mobile device educator observation process.

FIG. 58 is a flowchart of the TOWER mobile device observation process.

FIG. 59 is a first flowchart of the TOWER professional development process.

FIG. 60 is a second flowchart of the TOWER professional development process.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

The present invention comprises a teaching observation and evaluation system and method for mobile electronic devices. In a preferred embodiment, the system comprises a software application for mobile electronic devices which allows users (“observers”) to input evaluation, observation, and scoring data of classroom teachers in the field. The system includes a method for transferring the observation and scoring data via wireless networking means to a remote and secure administrative server. The following description of the mobile observation system is only one example of a preferred embodiment, with the understanding that variations on the concept are possible while keeping within the scope of the invention.

The overall system can be referred to as a Teacher Observation, Walkthrough, Evaluation, and Reporting platform (“TOWER”). The system is generally comprised of an administrative server (the “TOWER admin server”) which is in communication with multiple mobile devices employed by observers in the field.

TOWER Mobile Application

The mobile device may be any mobile wireless device capable of communicating with the TOWER admin server, including but not limited to the iPad tablet manufactured by Apple, or tablets running the Android operating system. Generally, and prior to a more detailed description below with respect to the various figures, when an observation is scheduled and assigned, it populates on the observer's calendar. If the user has a mobile device, the observations are visible as soon as the device is synchronized (“synced”) to the TOWER system. Observers can complete their observations on the mobile device equipped with the TOWER mobile software application. Observers can manage their schedule, and perform many operations, including but not limited to: (1) view all of their assigned evaluations or select a view of only their near-term work schedule; (2) make scheduling changes from their mobile device for flexible and efficient schedule changes; (3) save evaluations on their mobile device, regardless of the availability of a wireless connection, which means evaluations can progress on schedule and are safely stored on the mobile device until the observer syncs the device to the TOWER admin server. Following a synching operation, the uploaded evaluations are archived on the mobile device to avoid interfering with current and future evaluation schedules. However, users can continue to enter and exit the observation cycle as their workflows dictate.

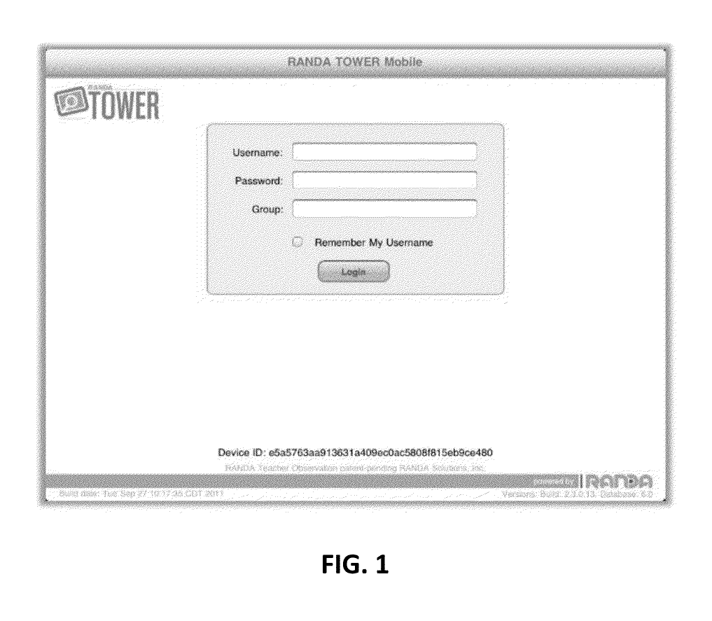

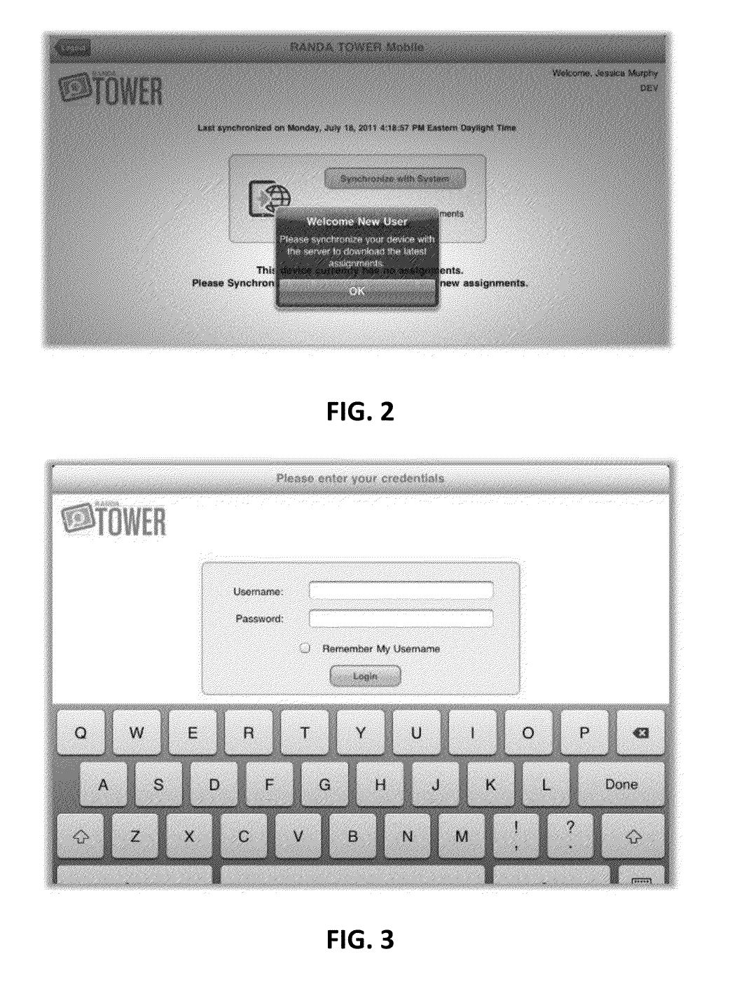

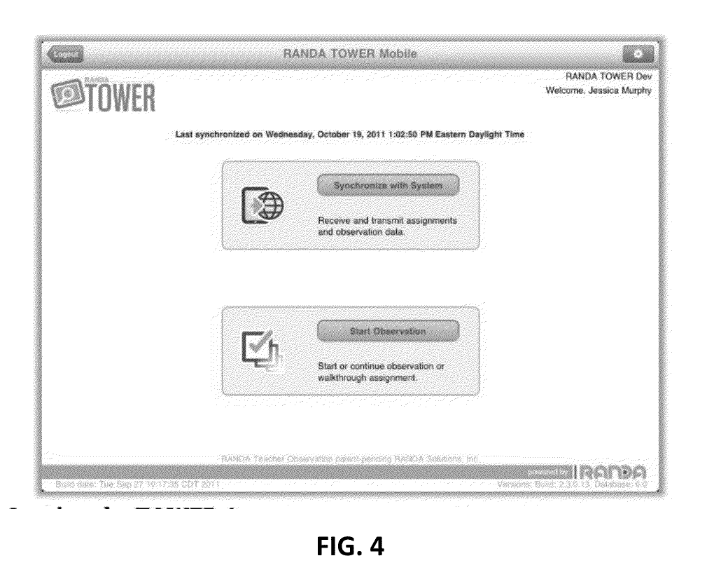

Turning now to the figures, FIG. 1 shows an image on a mobile teacher observation and evaluation system requiring initialization credentials. The first time a user opens the TOWER mobile app, it requires initialization on the mobile device and associated with the user's school system. To initialize the app, a username, password, and Group/Activation Code are required. When initialization is complete, the user is notified as depicted in FIG. 2, and the normal login window is displayed as shown in FIG. 3. Once the user is logged in, a page is displayed to the user as shown in FIG. 4, which includes options for logout, application settings, synchronization with the TOWER admin server, and Start Observation.

Importantly, the first time the TOWER mobile app is run, an initial synchronization is required. During a synchronization with the TOWER admin server, the device is updated with information that is applicable to all users assigned to that particular mobile device. This action may accomplish a number of tasks which are essential to ongoing activities. For example, it may include downloading of any new usernames and passwords assigned to the device, and downloading of any current assignments to be completed on the device. If an assignment is rescheduled on the TOWER admin server, the change will be reconciled on the mobile device during the next sync. The sync will also upload to the TOWER admin server any observation, walkthrough data, or other data that has been changed using the mobile device since the last sync. The sync will also download to the mobile device any data concerning a completed observation or walkthrough that has been edited (using the website via the TOWER admin server) since the last sync. During active observation periods, the user will typically sync at the beginning and end of each observation day. If there are multiple users using the same mobile device, each user must sync before and after using the TOWER mobile app.

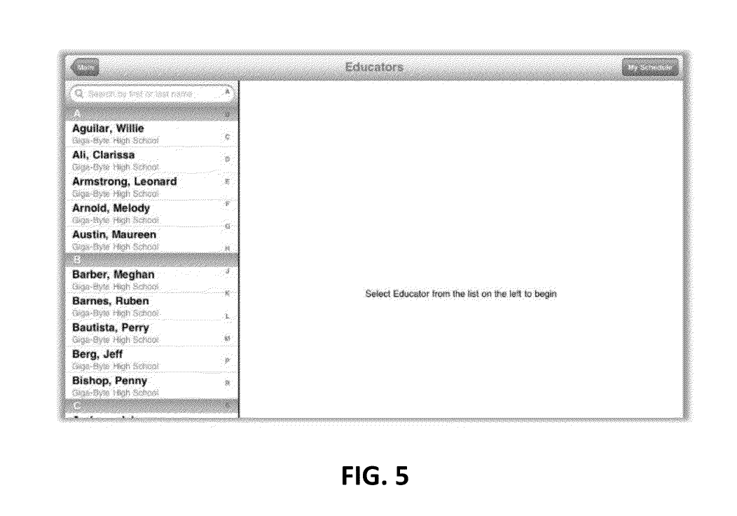

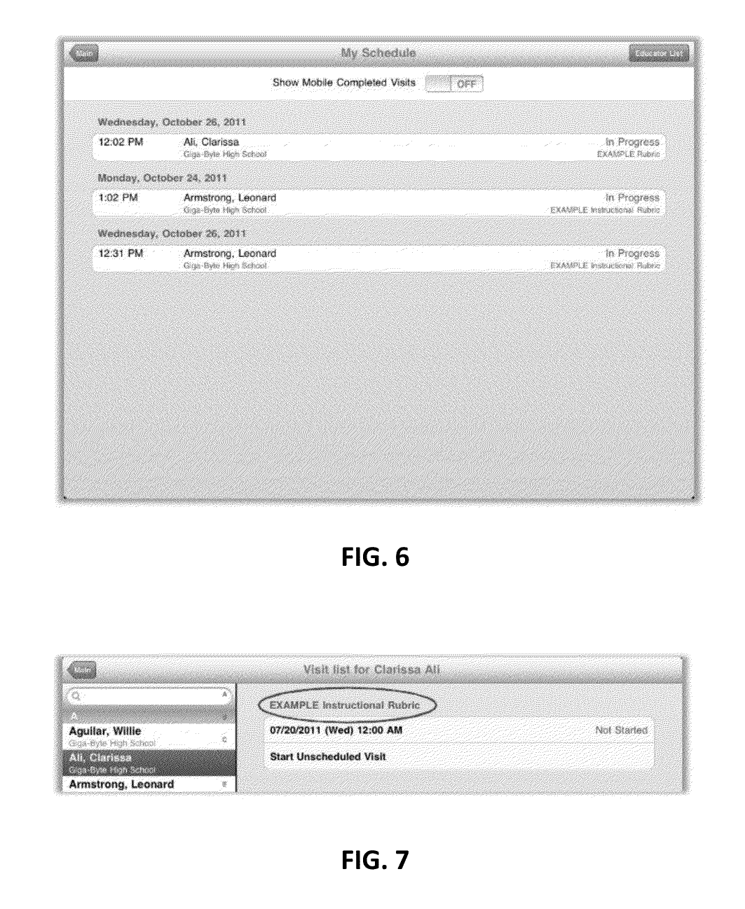

Upon the user's selection of the Start Observation button in FIG. 4, the user will be presented with either an Educator List or a My Schedule page, depending on preferences set within the mobile app. The TOWER mobile app requires the location of the user performing the observation to allow for proper syncing in different times zones and for geo-location tracking purposes. FIG. 5 shows an Educator List for selection of the educator to be observed, while FIG. 6 shows the My Schedule page with scheduled educator visits for an observer. The user can toggle between these views by clicking on a button in the top right of the display.

Upon selection of an educator from the Educator List, the visit list for that specific educator will be displayed as shown in FIG. 7. The visit list can be organized by rubric, such as the example rubric entitled “EXAMPLE Instructional Rubric” shown in the figure. Rubrics being used for the evaluation or observation will be preloaded onto the mobile devices. The rubrics will include, but not be limited to, the various standards, strands, performance indicators, and domains used for a particular observation or evaluation. These rubric fields may be toggled open and closed, depending on the length of the field and the size of the mobile device screen. Each rubric will have input fields for scores, level assignments, notes, observations, and other pertinent data.

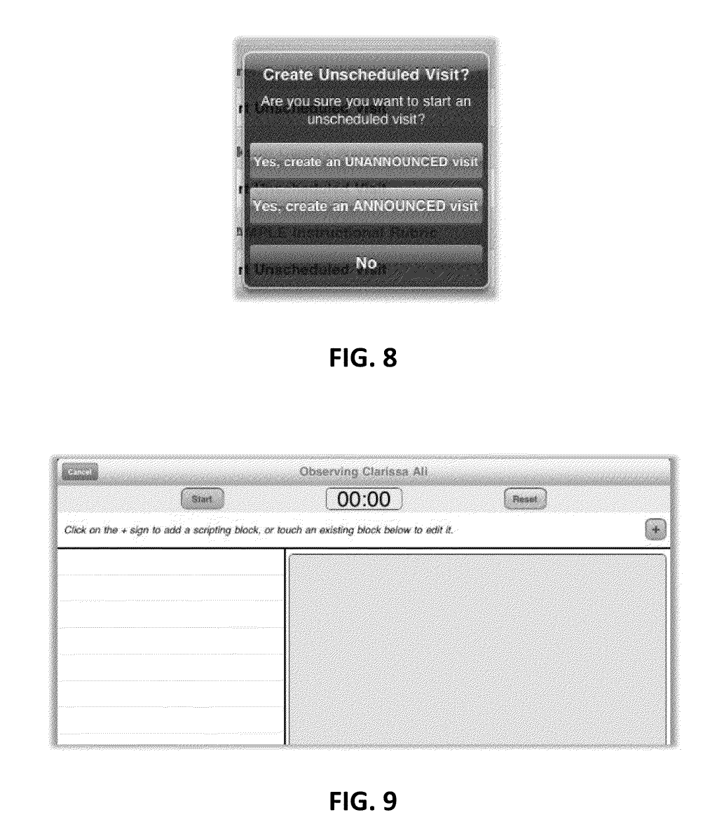

The user can either select a visit that has been pre-assigned, or he can start an unscheduled visit. Pre-Assigned Visits are labeled with a date and time, but can be started prior to or after the scheduled time if needed. If a pre-assigned visit is rescheduled on from the website for the TOWER admin server, the change will be reconciled on the mobile device during the next sync. Unscheduled Visits can be started by selecting the box labeled Start Unscheduled Visit. Optionally, the mobile app may allow the user to specify whether the unscheduled visit is announced or unannounced, as shown in FIG. 8. The visit list displays the title given to each visit (if any), the date it should take place, and its status. There are at least four potential statuses: (1) Not Started, meaning that the user has not begun working on the observation; (2) In Progress, meaning that the user has started the observation but has not completed it; (3) Mobile Completed, meaning that the user has finished the observation; and (4) Overdue, meaning that the due date for the visit has passed. Possible additional statuses that may be noted are: (5) Scheduled, (6) Downloaded (to the mobile device), and (7) Overdue. To start or continue work on a particular visit, the user selects the box containing the date and status shown in FIG. 7.

With reference to FIG. 6 and the My Schedule page, this display shows the scheduled and in-progress visits sorted by educator name and date, along with the status of each event. Each visit's date and time, educator name, school, status, and rubric are clearly identified for the user. From this view, the user can continue working on any visit listed by selection of the corresponding box.

After the user selects an observation, the scripting page will be displayed as shown in FIG. 9. The scripting page is used to take notes during the observation of the specific educator. Each individual note is known as a “scripting block”, and each of the scripting blocks will be associated with one or more indicators, e.g., Planning: Instructional Materials, Learning Environment: Culture of Respect, Instruction Strategies: Lecturing, etc., in a mapping process to be further described herein. The scripting page may also include a stopwatch functionality to assist the user in timing the observation. To add a scripting block, the user selects the plus sign located on the right side of the display. The new scripting block is labeled with the time at which it was created, and the time elapsed since the timer was started is also included in parentheses.

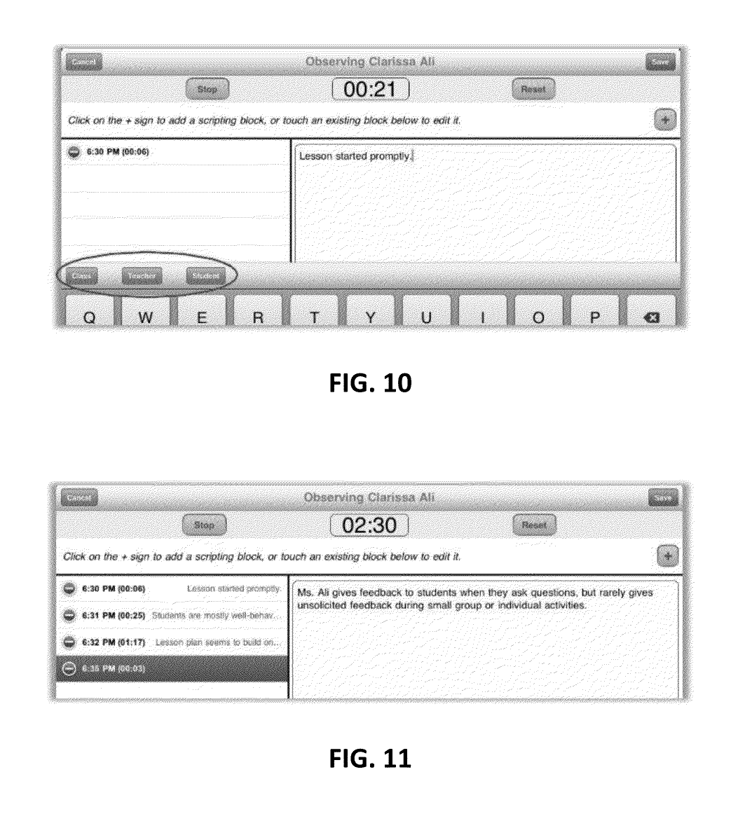

The keyboard on the mobile device is used to enter the notes into the display. To save on typing time, shortcut buttons for common words, such as “class”, “teacher”, and “student”, may be located at the top of the keyboard, as shown in FIG. 10. These shortcut buttons are customizable based on the observer's note taking process. When the scripting block is complete, the user can again select the plus sign to add successive scripting blocks as desired. Scripting blocks can also be deleted by selection of the minus sign. FIG. 11 shows multiple scripting blocks recorded during the observation of a specific educator.

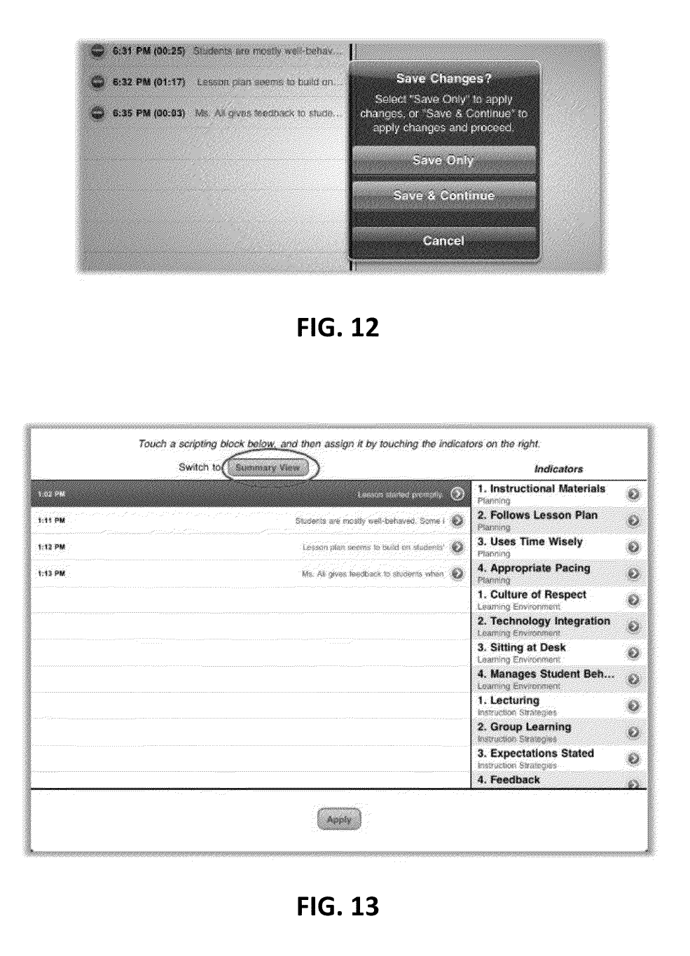

Once the user finishes observing the educator, the observation can be saved to the mobile device by selection of the Save (or a Next) button at the top right of the display of FIG. 11. In one embodiment, a pop-up notice will provide the user with three options, as shown in FIG. 12: (1) Save Only—selected if the user is not ready to proceed to Mapping, but would like to save the work on these scripting blocks to return to at a later time; (2) Save & Continue—selected if the user is finished scripting and is ready to proceed to Mapping; or (3) Cancel—selected to return to scripting. Selection of the Save & Continue option will cause the TOWER mobile app to display the Mapping mode of operation. In an alternate embodiment, the user can be presented with an option to remove any scripting blocks with no content, or to skip and retain empty scripting blocks to record the observer's time.

The Mapping mode is presented to the user initially as a Block View shown in FIG. 13. In this mode, the user associates each of the scripting blocks created during an observation (listed in the large box of FIG. 13) with one or more Indicators (shown in the far right column of FIG. 13). These Indicators may be any quality or attribute about the educator's performance which may be of interest to persons evaluating the educator, such as use of time, pacing, technological integration, culture of respect, etc.

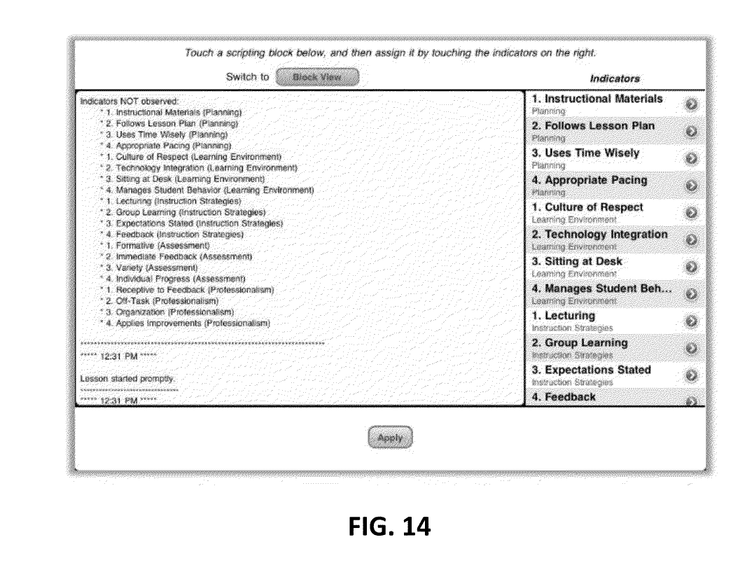

A Summary View of the Mapping mode is also available as shown in FIG. 14, which displays the list of Indicators that have not yet been mapped to scripting blocks. The main box in this view can be scrolled, and the full text of each scripting block is included. As the user maps scripting blocks with Indicators, the Summary View will be updated to show the progress. The user can easily return to the Mapping process in Block View by selection of the Block View button at the top of the page.

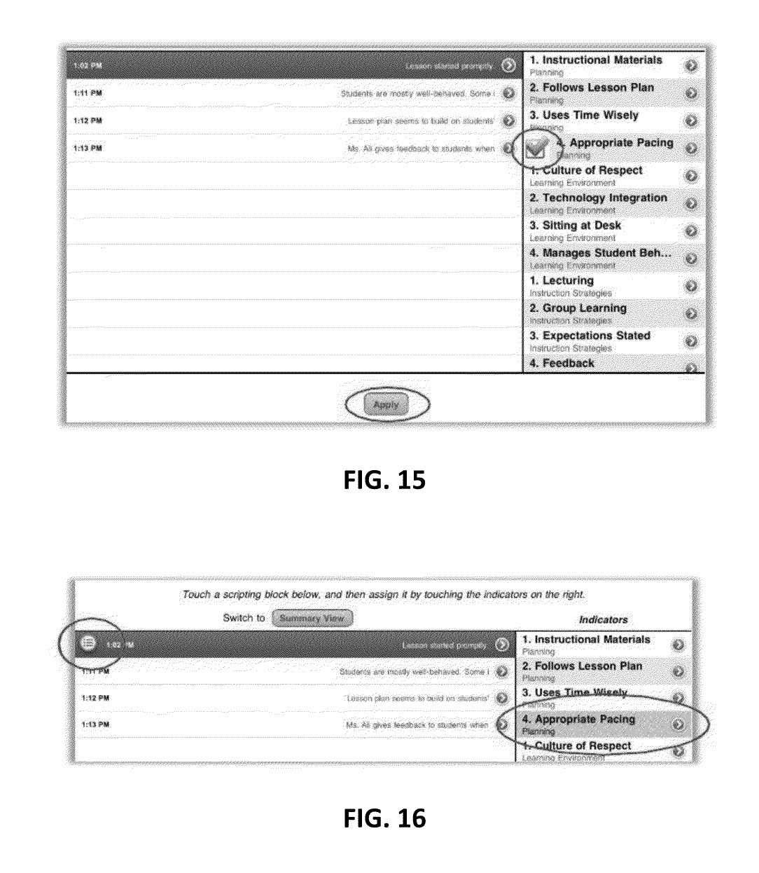

When in Block View, the user begins mapping a scripting block with an Indicator by selecting the scripting block, which will cause the scripting block to become highlighted in blue as shown in FIG. 15. The user then selects the corresponding Indicator in the right column, causing a green checkmark to appear, signifying that the Indicator has been selected. If the user is satisfied with the map, the Apply button (located at the bottom of the page) is selected to formally map the scripting block with the Indicator. As shown in FIG. 16, the Indicator will also be highlighted in orange after the map has been applied. Furthermore, an icon will appear on the left side of the display for each scripting block that has been mapped to an Indicator.

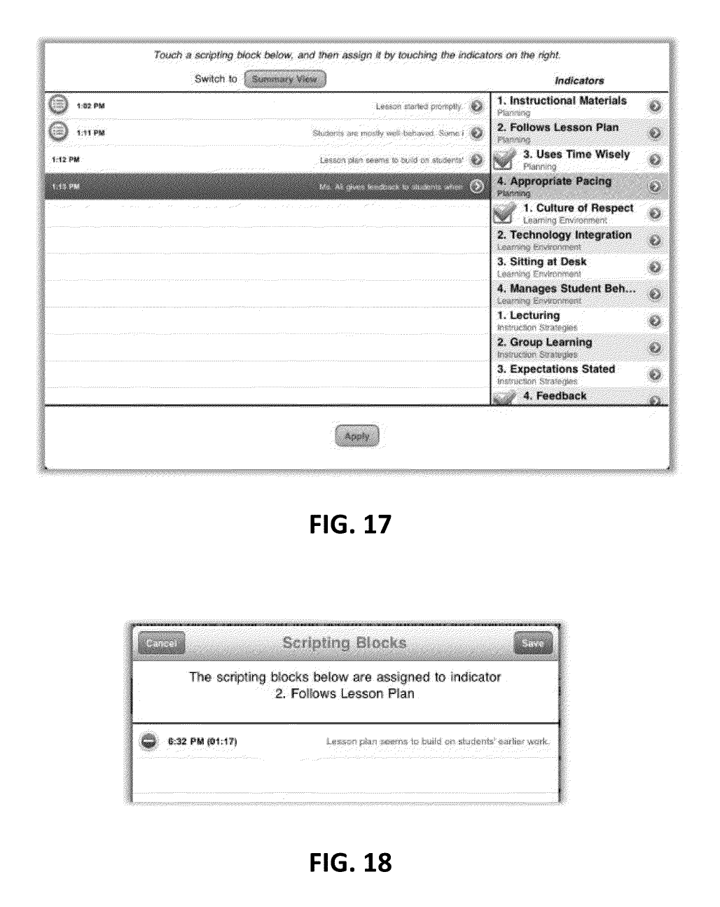

The user can also map multiple scripting blocks with a single Indicator in the same manner described above Likewise, the user can map a single scripting block to multiple Indicators, as shown in FIG. 17. The user continues to map the scripting blocks with Indicators until all of the scripting blocks are mapped to their appropriate Indicators. The user can easily see which scripting block(s) are assigned to an Indicator by selecting the blue arrow located to the right of the Indicator name. The user can also delete the relationship created between the Indicator and the scripting block if they are not satisfied with the map. The list of scripting blocks mapped with the selected Indicator will be displayed in a pop-up box as shown in FIG. 18.

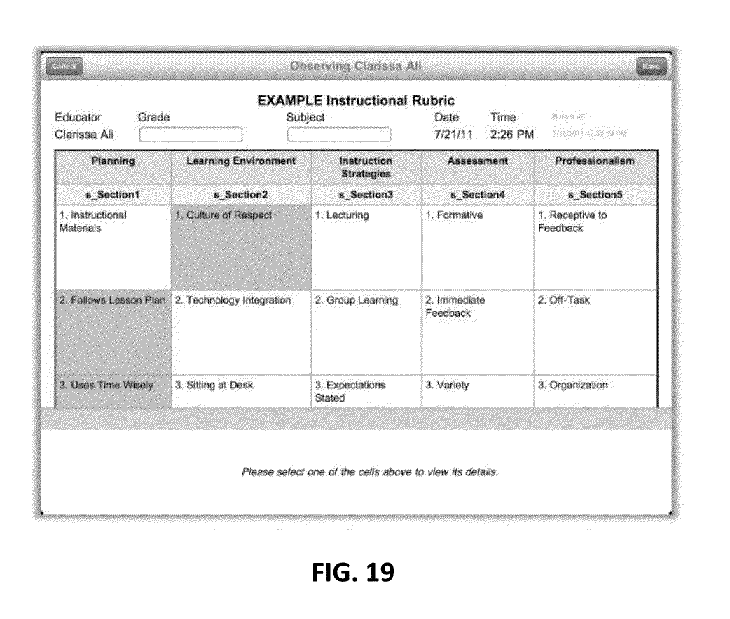

Once the scripting blocks have all been mapped to their Indicators, the educator's performance can be scored in accordance with whatever rubric is to be applied to the evaluation. In the examples described herein, the rubric includes a number of sections, including Planning, Learning Environment, Instruction Strategies, Assessment, and Professionalism. Each of those sections forms a column on the scoring page grid of FIG. 19, and each section further includes a plurality of Indicators. For example, the Planning section includes the Indicators of Instructional Materials, Follows Lesson Plan, and Uses Time Wisely, etc. The other sections include Indicators as shown in the scoring page at FIG. 19. Indicators which are highlighted have scripting blocks which have been mapped to those Indicators.

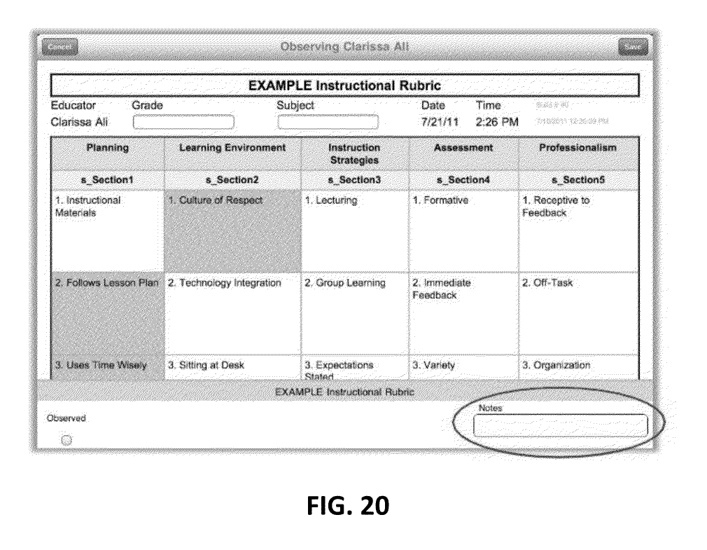

The user can select the rubric name near the top of the scoring page, which causes a Notes section to appear as shown in FIG. 20. When the user selects the Notes field, the mobile app displays all of the notes and scripting blocks associated with the observation, and additional notes can be added. Fields are also provided above the scoring grid for entry of the grade and subject taught by the observed educator.

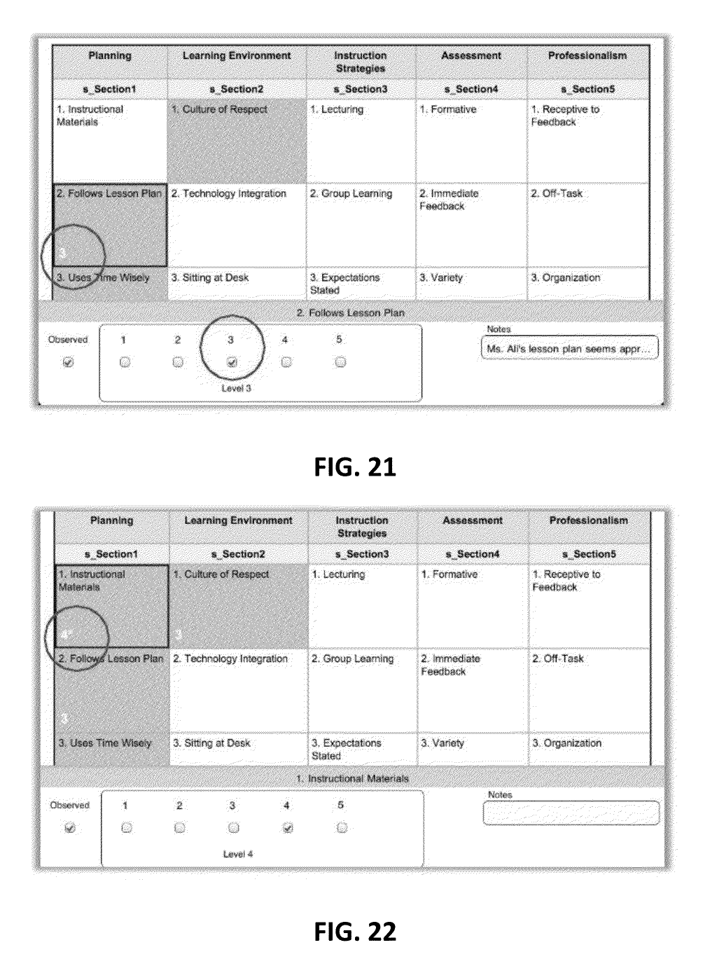

Scoring for each Indicator is accomplished by selecting the Indicator on the grid, which then highlights the selected Indicator and displays a panel below with an “Observed” checkbox, a plurality of score selection boxes ranging from 1-5, and a notes field, as shown in FIG. 21. If the user selects an Indicator with one or more mapped scripting blocks, the Observed checkbox will be pre-checked. If the user selects an Indicator that has no mapped scripting blocks, the user can manually check the Observed box. Selection of the notes field will display the scripting blocks that were mapped with the Indicator and allow the user to add further notes. Selection of a score number causes that number to appear in the Indicator box, as shown in FIG. 21 with respect to the Indicator for Follows Lesson Plan. All other scores are added to the scoring page grid in a similar manner.

Once a score is added to any Indicator, its box on the scoring page grid will be highlighted, and the score number will appear in the lower left corner. The score for any Indicator that was not previously mapped with scripting blocks will have an asterisk (*) next to the score number, as shown in FIG. 22.

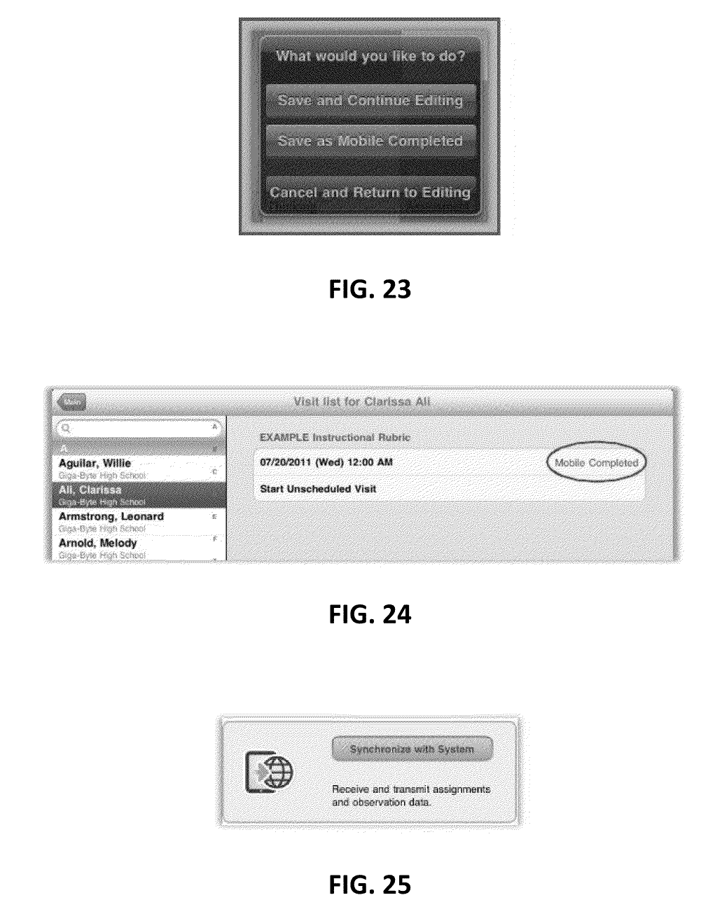

When the desired scores have been added, the user can save the scoring progress to the mobile device. In a preferred embodiment, a pop-up box, such as shown in FIG. 23, presents the user with three options: (1) Save and Continue Editing—saves the most current changes and returns to the scoring grid to continue working; (2) Save as Mobile Completed—means that the user is finished with the observation (the user cannot edit the observation on the mobile device once it has been saved as completed); and (3) Cancel and Return to Editing—returns to the observation form without saving the most recent changes. In an alternate embodiment, the user can be presented with an option to Complete, or Complete and Email to send the progress to another user of the TOWER system.

FIG. 24 shows a mobile observation as “Mobile Completed” for a specific educator. Regardless of the Mobile Completed status, once the progress has been saved for a particular observation, other observations and scorings can be made for the same or for other educators. When the user is finished with the mobile app, the Main button can be selected to display the main page with the Synchronize with System button, as shown in FIG. 25. Syncing is required for all of the observation and scoring data on the mobile device to be transmitted to the TOWER admin server.

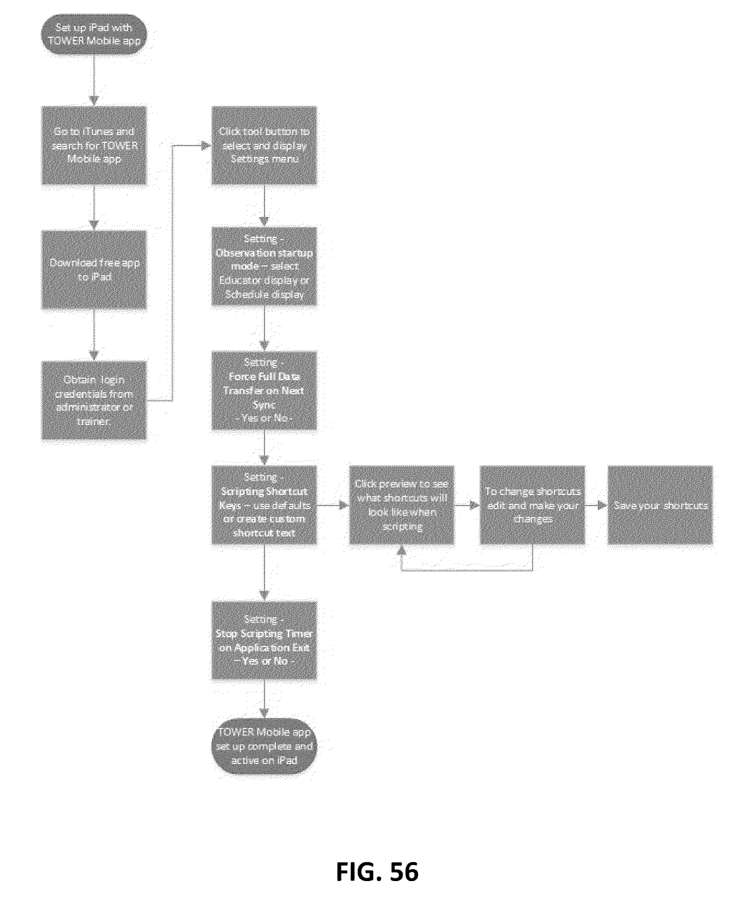

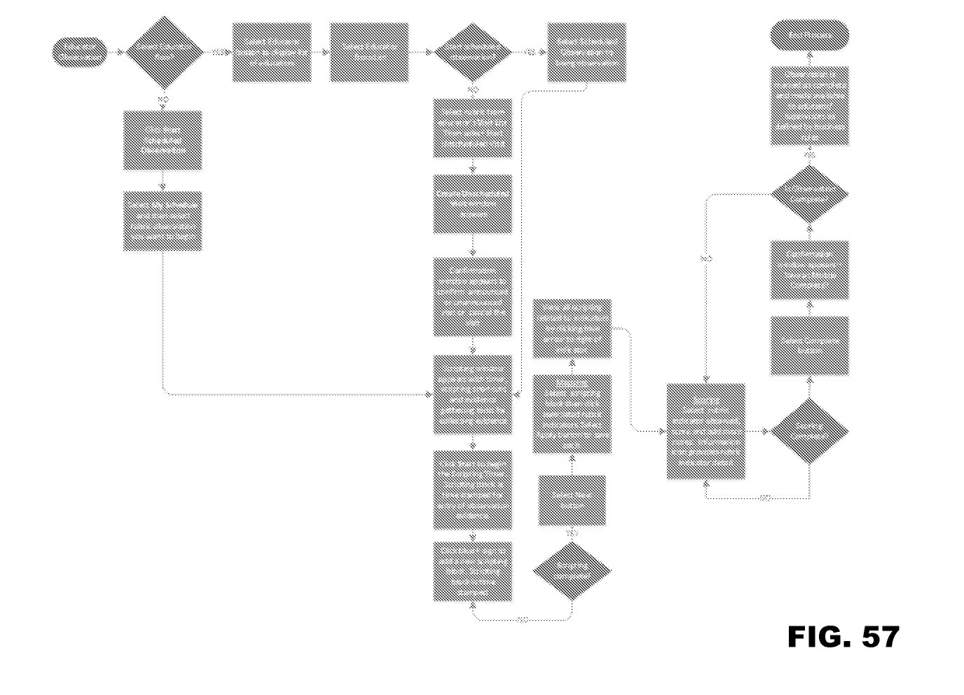

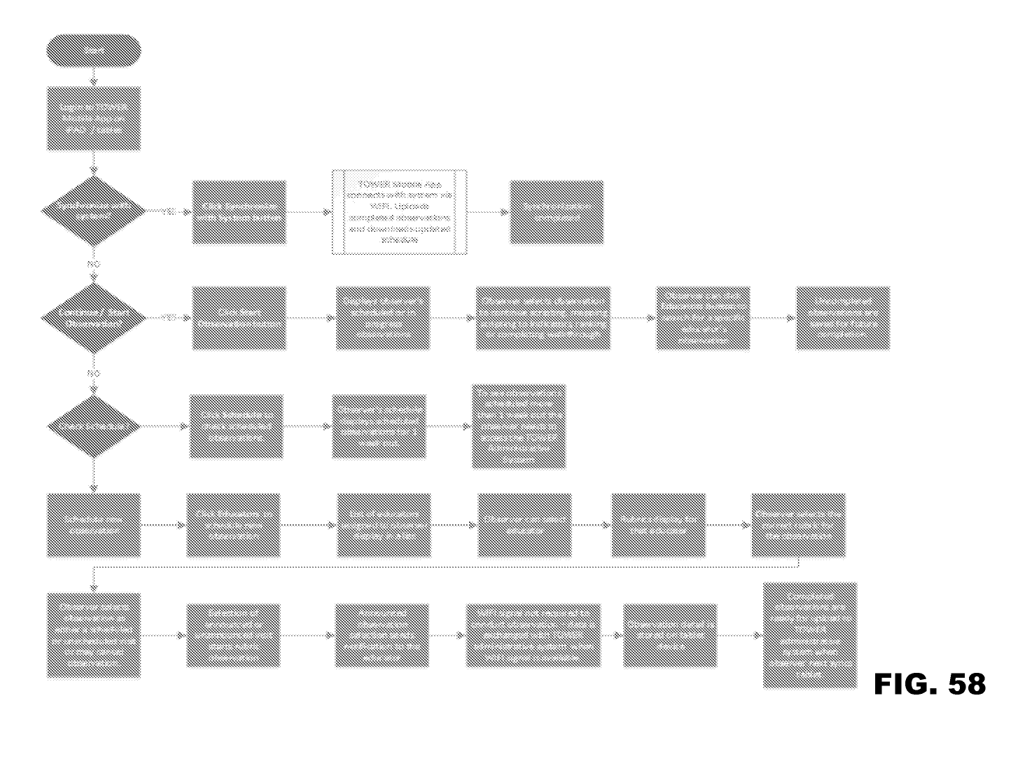

Bearing in mind the above description of features in connection with the TOWER mobile devices, FIGS. 56-58 are flowcharts related to setup and operation of the TOWER mobile devices. For example, FIG. 56 is a flowchart of the TOWER mobile device setup process. FIG. 57 is a flowchart of the TOWER observation process as it relates to mobile devices, and is complementary to the user interface images shown in FIGS. 1-25. Similarly, FIG. 58 is a flowchart of many of the TOWER mobile device processes as they relate to scheduling, selection of educators, the observation process, and synchronization with the TOWER admin server.

TOWER Administrative Server and Web Interface

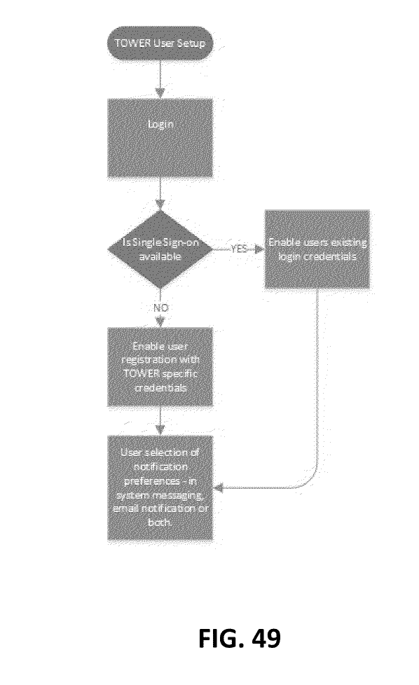

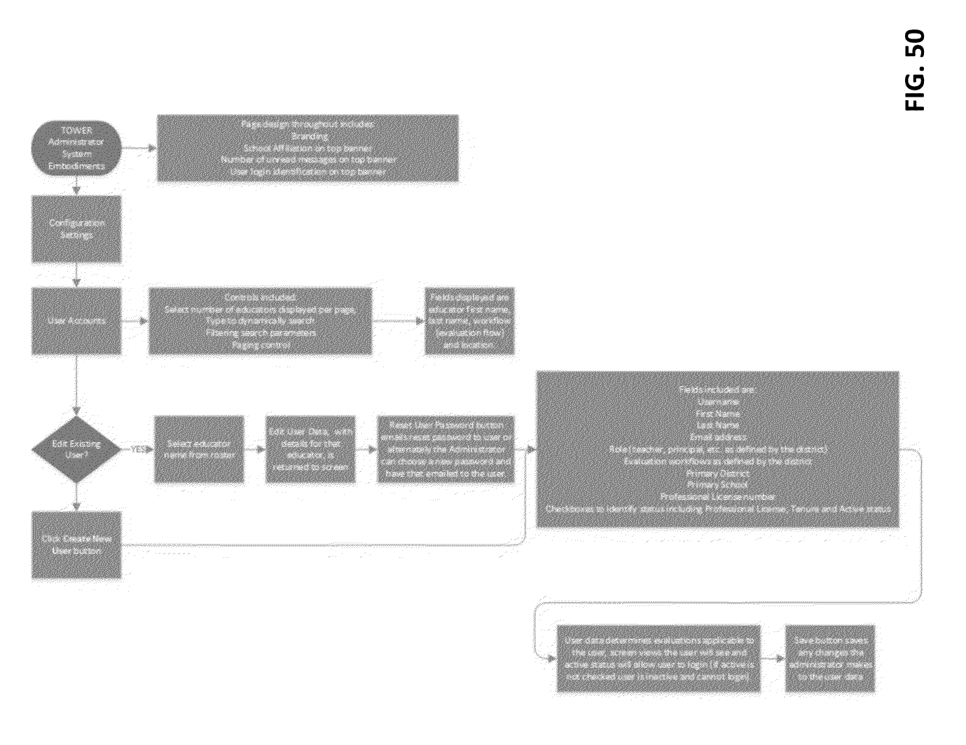

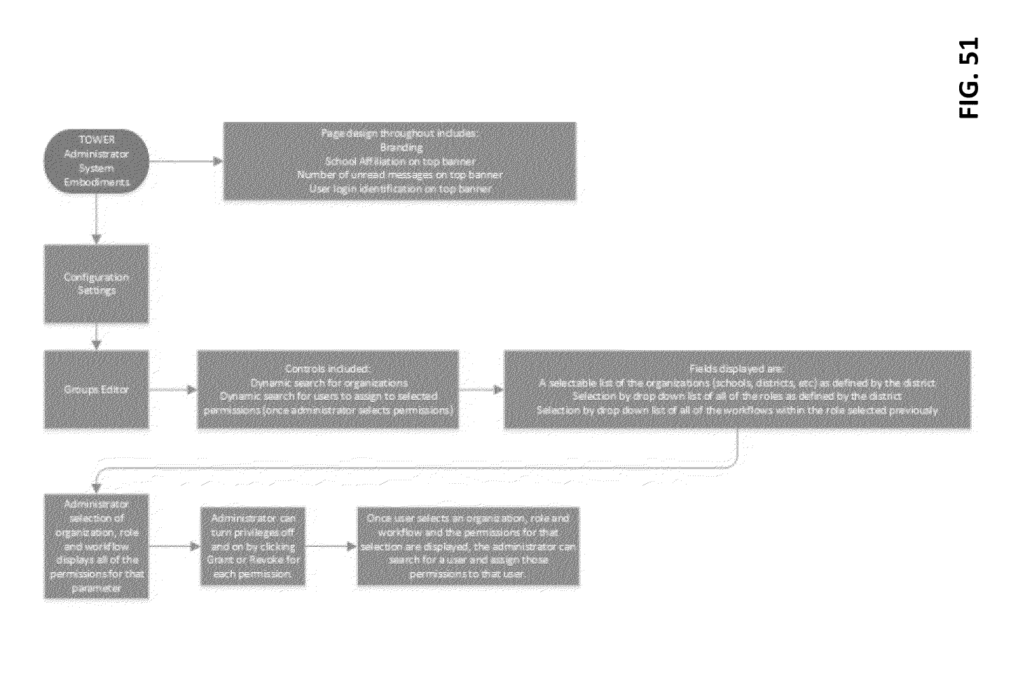

With respect to the TOWER admin server, an Internet web-based user interface is also provided for use by those having sufficient credentials to schedule and edit observations, edit scores, manage professional development options, edit access rights by certain users, and configure various system settings. FIG. 49 depicts a typical process for managing users authorized to access the TOWER system, including establishing access credentials and notification preferences. Similarly, FIG. 50 depicts a process for the management of user accounts, while FIG. 51 shows a process for managing groups of authorized users, such as those within a particular school or district.

The TOWER web site also enables educators to complete their part (if any) of the observation process, including self-assessment forms, goal setting forms, professional growth plans, lesson plan submittal, and similar information. Such web-based user interface is typically employed on desktop or laptop systems, and for purposes that generally do not involve actual, real-time observations of educators.

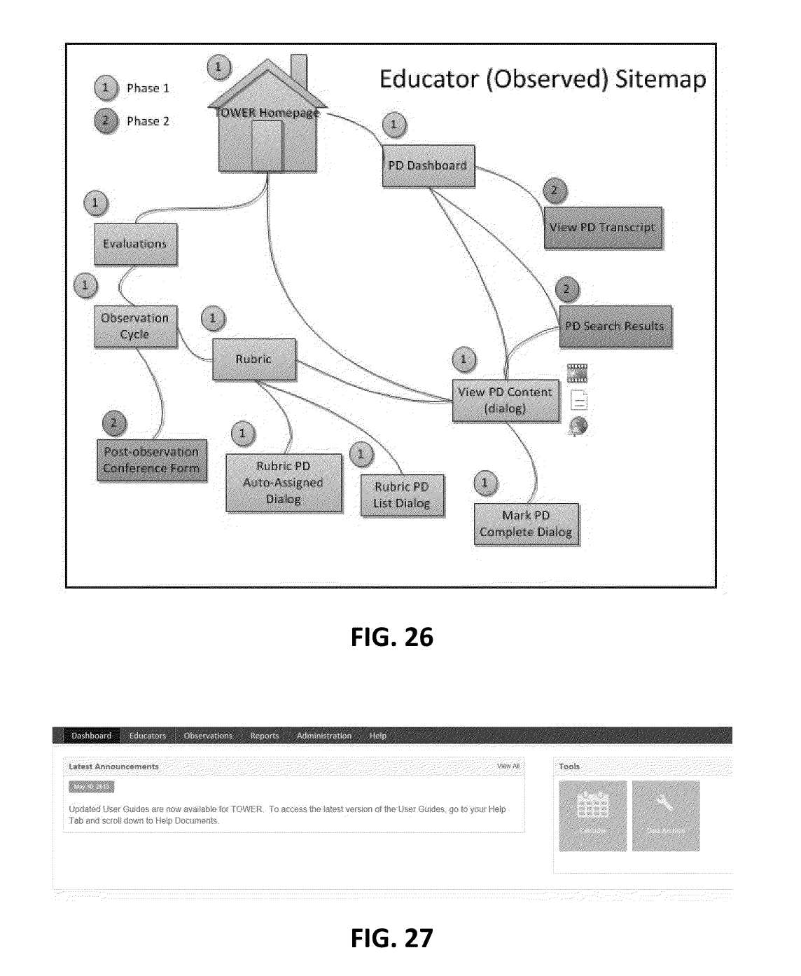

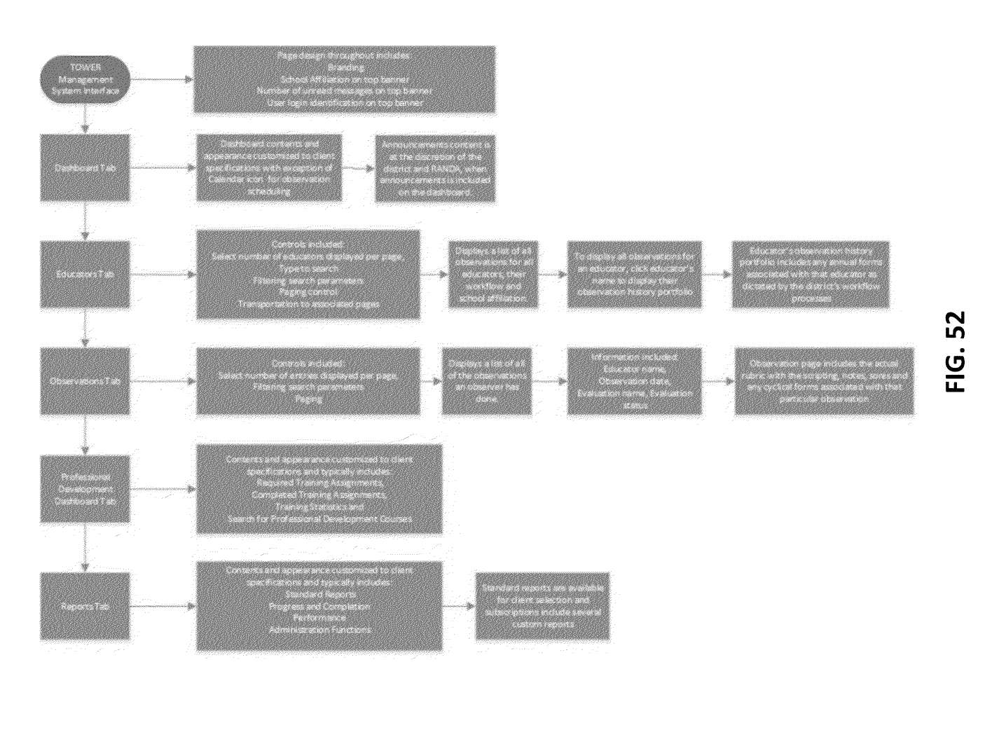

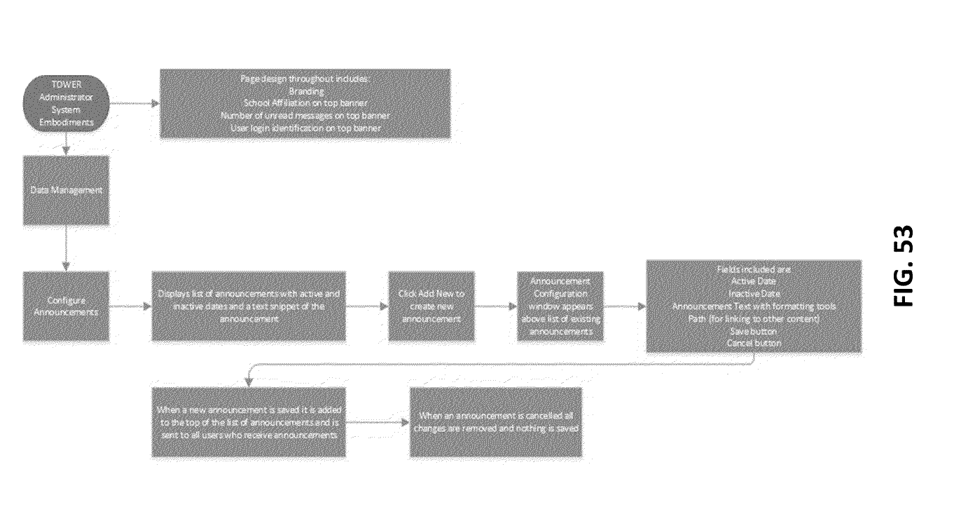

When logged in to the TOWER system, the user is presented with a home page or dashboard interface having a number of tab options corresponding to pathways to manage observations, educator information, professional development, reports, and administrative options, as shown in FIG. 27. A schematic diagram is also shown in FIG. 26 depicting typical pathways to those options. More specifically, FIG. 52 illustrates a flow of options available to the user from the TOWER home page. Importantly, these display of particular tabs (and their specific options) is based on the permissions given to each user during the implementation of the TOWER system and the role of the user in the system. The dashboard tab seen in FIG. 27 conveniently provides access to the calendar for scheduling of observations and related events, along with any announcements relevant to the school district or system status. For example, FIG. 53 illustrates a process for managing and configuring announcements within the TOWER system. It should be understood that many other options may also be presented to the user from the dashboard tab.

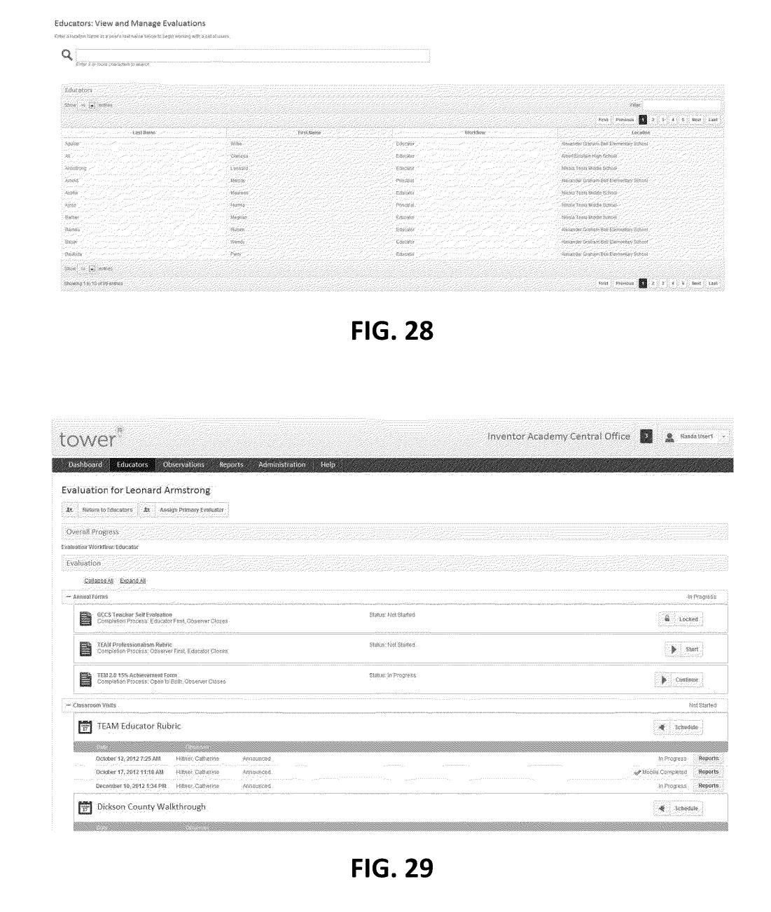

When a user selects the Educators tab, a display is presented as shown in FIG. 28 identifying all educators that are affiliated with the user's access rights. A filter field of provided to allow searching for specific educators, and those educators' names are shown along with their school. Selection of a particular educator enables the user to view visits corresponding to observations, and also to edit those observations and scores as further explained below. For example, selection of an educator as shown in FIG. 29 displays the educator portfolio, which includes the name, annual forms that must be completed which are related to performance, and classroom visits. Note that the interface in FIG. 29 also provides a pervasive upper banner which displays the organization (or school) name, the identity of the user, and access to any messages to the user.

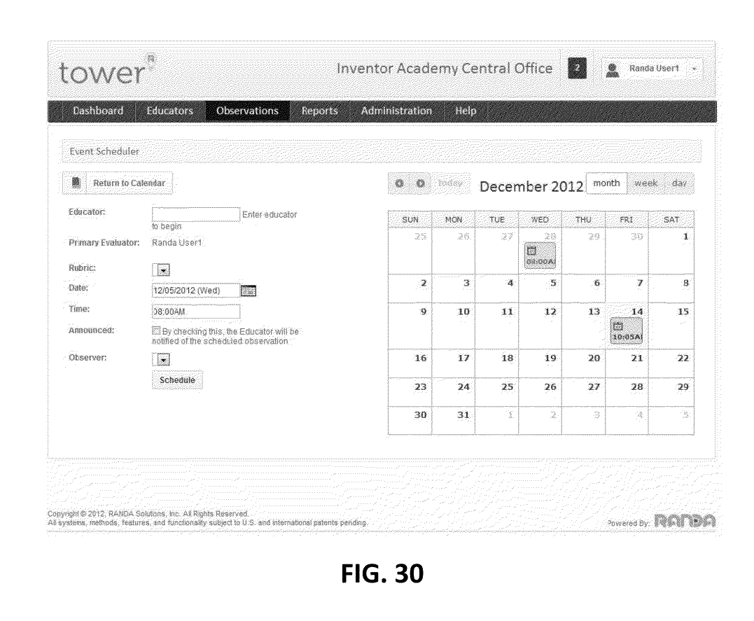

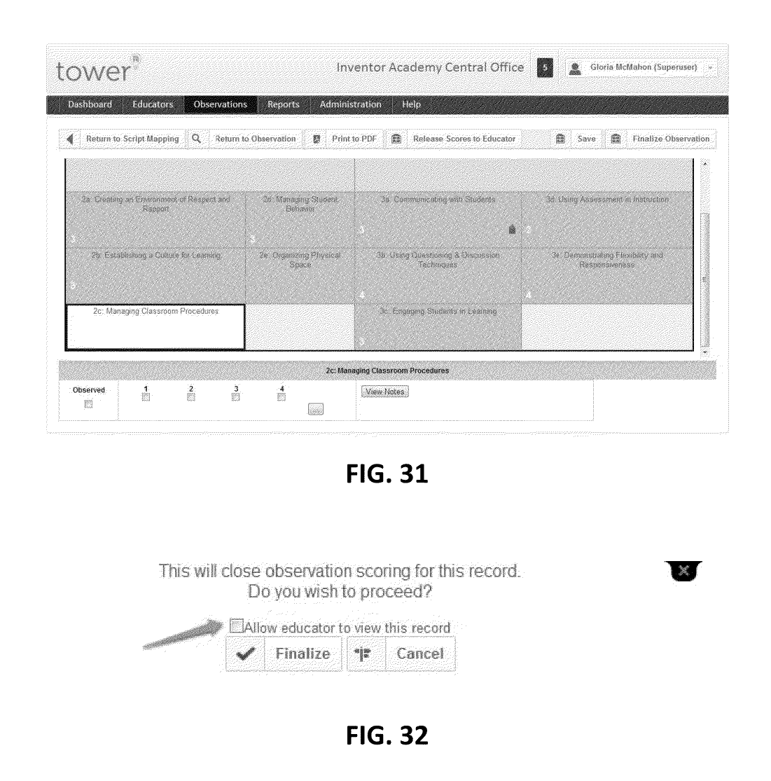

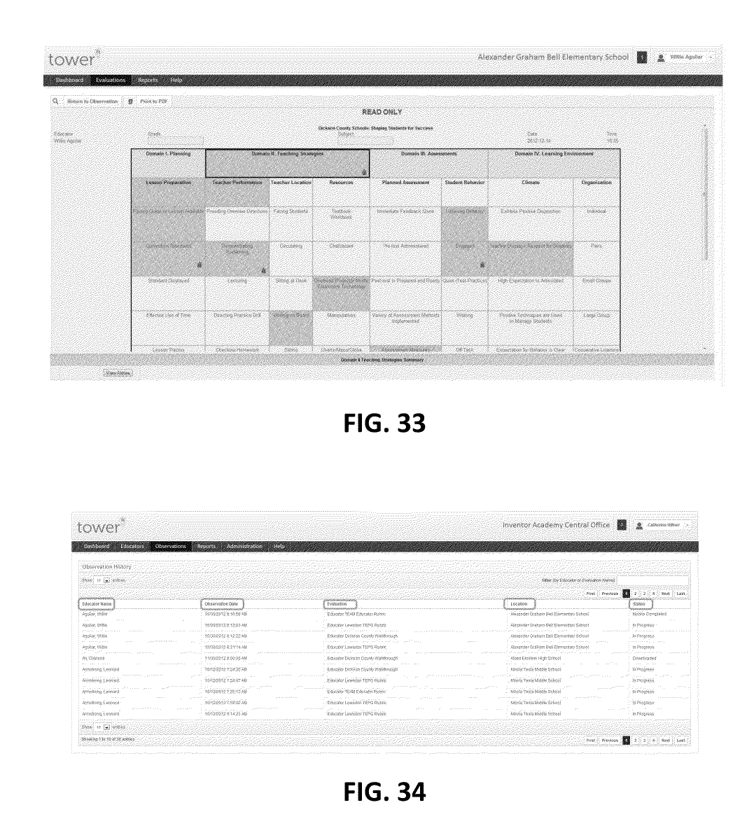

Under the Educators tab, the user can schedule events similar in fashion to the TOWER mobile app as described earlier. For example, the interface in FIG. 30 permits the user to schedule an event corresponding to a specific educator and a particular rubric predefined by the school or district. Also, any observations that have been synced to the TOWER admin server as “Mobile Completed” can be viewed and edited as shown in FIG. 31, including editing of scores, viewing scripting blocks, and adding notes. Once all editing of the observation is finished and ready to “finalized”, the user is presented with the option shown in FIG. 32. An option is also available for allowing the educator to view the finalized observation. If the observation is finalized, then the observation becomes “read only”, as indicated in FIG. 33 when viewing a finalized observation. In all cases, however, administrators with sufficient access credentials may be permitted to modify observations despite their “read only” status, especially if it is learned that an incorrect rubric was used, an observation was accidently deleted, the wrong educator was observed, and in similar extenuating circumstances.

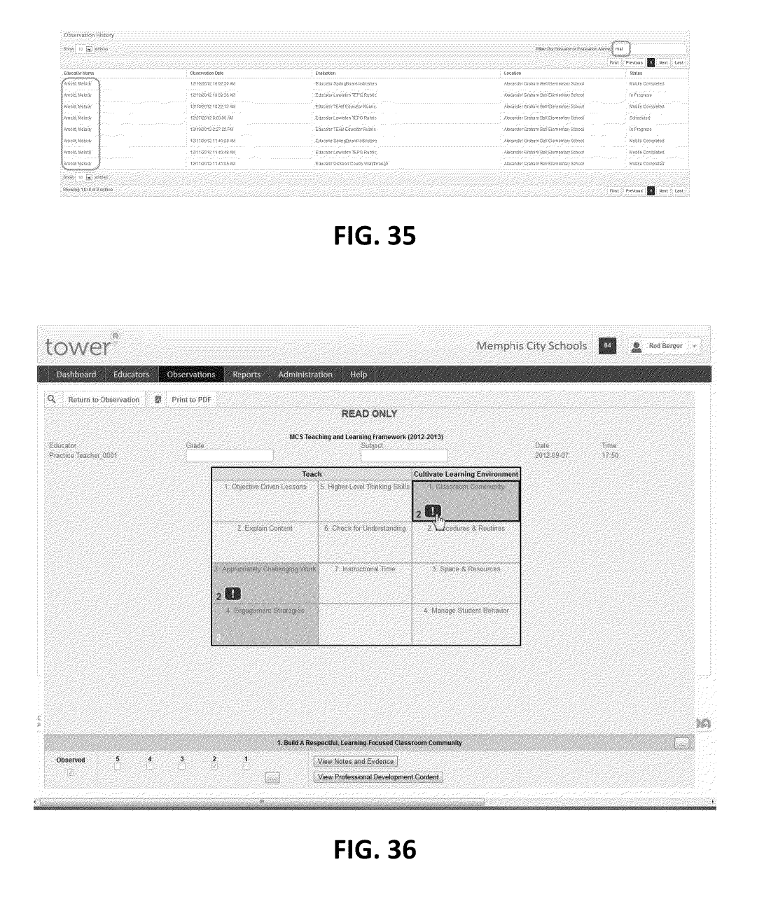

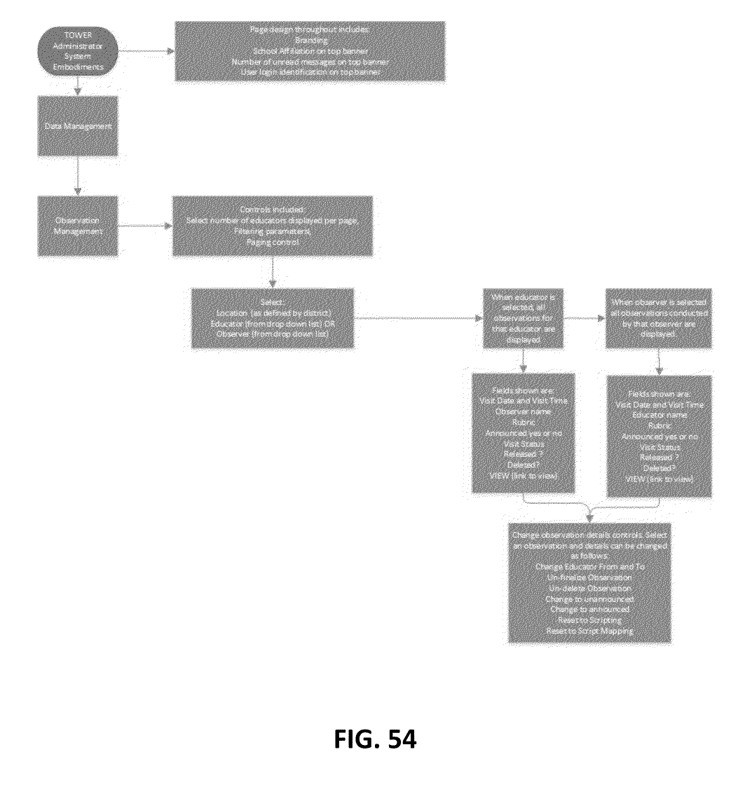

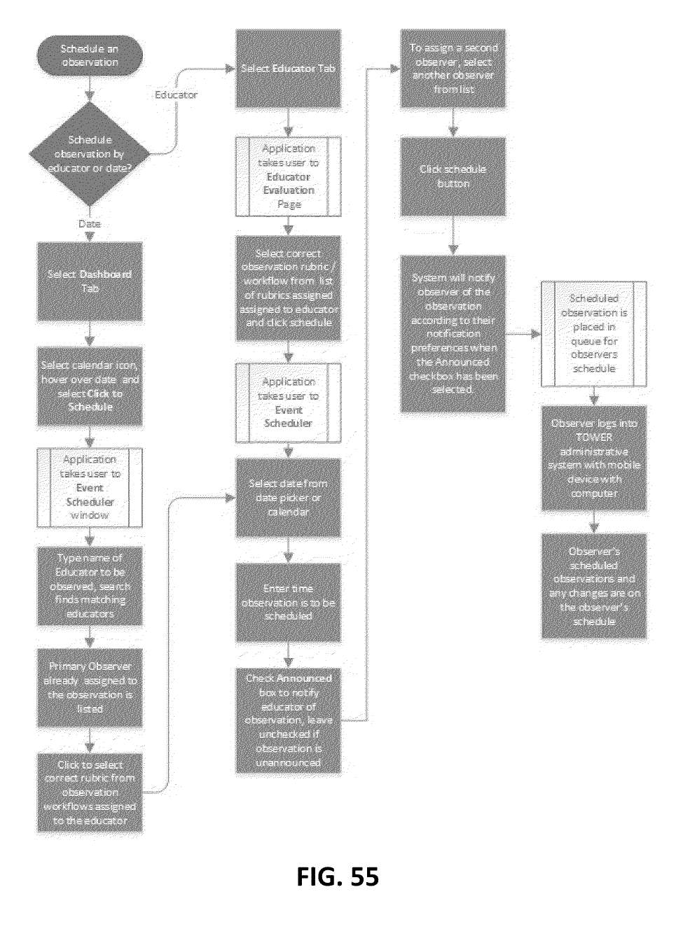

Similar to the Educators tab, the Observations tab of FIG. 34 is another pathway to edit observations as described above. Using the filter field depicted in FIG. 35, the user can filter names so that only those events relevant to a specific educator are displayed. Note that the status of any such events are also provided in the far right column, which conveniently allows the user to select those events which are ready for further review, editing, and finalization. FIG. 54 illustrates a typical process for managing observations from within the TOWER admin server. Similarly, FIG. 55 depicts a process for scheduling observations for one or more observers, and how the observer accesses the scheduled events from the TOWER mobile app.

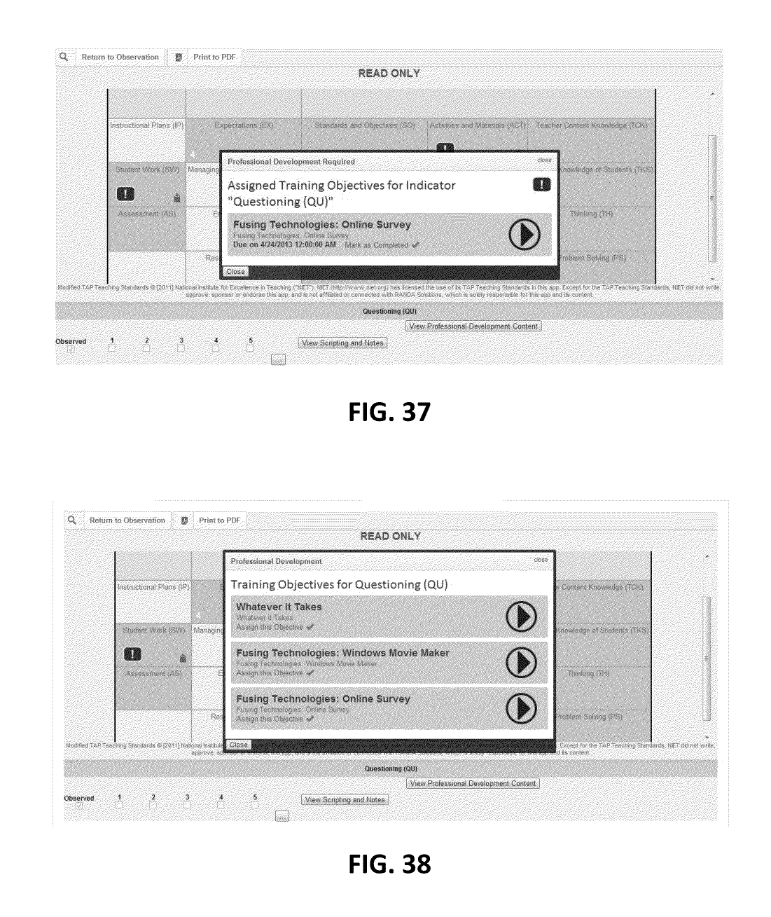

In a preferred embodiment, FIG. 36 is another illustration of a finalized observation having alerts regarding any required professional development that may be required based on the scores. Note that those indicators which have received a score of 2 in FIG. 36 includes such alerts. Whether and how such features are implemented for any particular school or district may be flexible, and they can be customized based on the preferences and requirements of the school or district administrators. When the user selects the alert, a pop-up box is displayed notifying the user that professional development (PD) is required based on the low score, as shown in FIG. 37. In this instance, a PD course offering remedial education relevant to the indicator is provided. The user, typically the educator, can easily select and view the PD course from within the TOWER system. Importantly, any and all PD courses which are recommended to the user should be displayed within the TOWER system, including slide presentations, videos, or any other interactive coursework.

FIG. 38 shows an option available to school principals or district staff to assign specific PD coursework (training objectives) to specific indicators based on scores. Once such training objectives are assigned to those indicators, the educator is presented with those PD options as described with respect to FIG. 37.

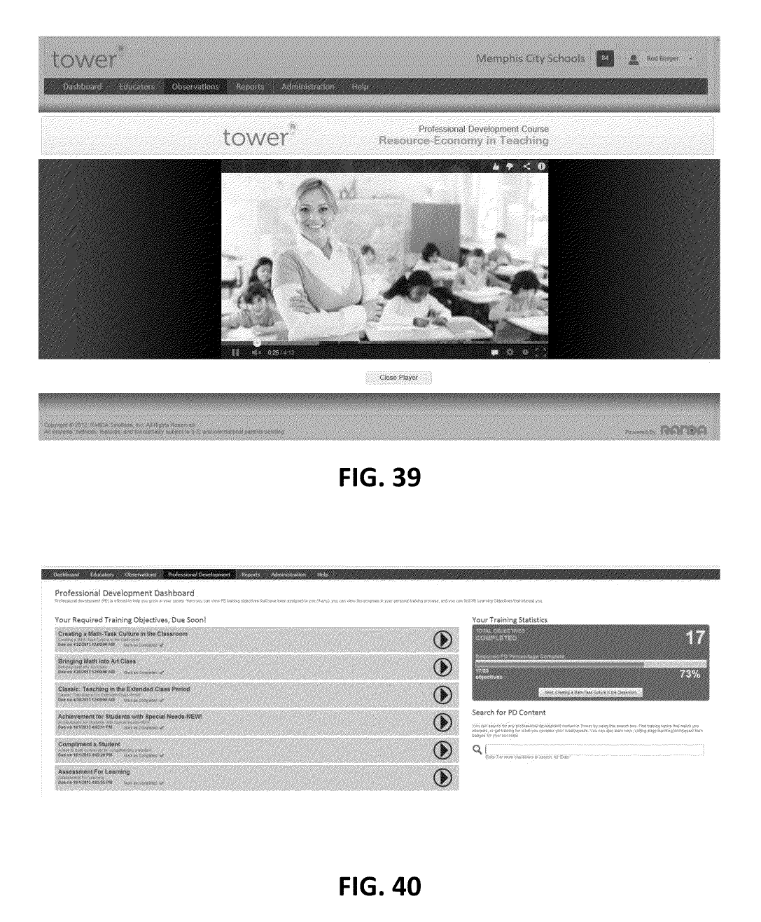

An example of a PD presentation viewable by the educator is shown in FIG. 39. Note that any applicable media player is embedded within the TOWER system, such that all PD work does not require exiting the TOWER system. Upon viewing the remedial PD coursework, the requirement may be marked by the educator as completed as shown in FIG. 37.

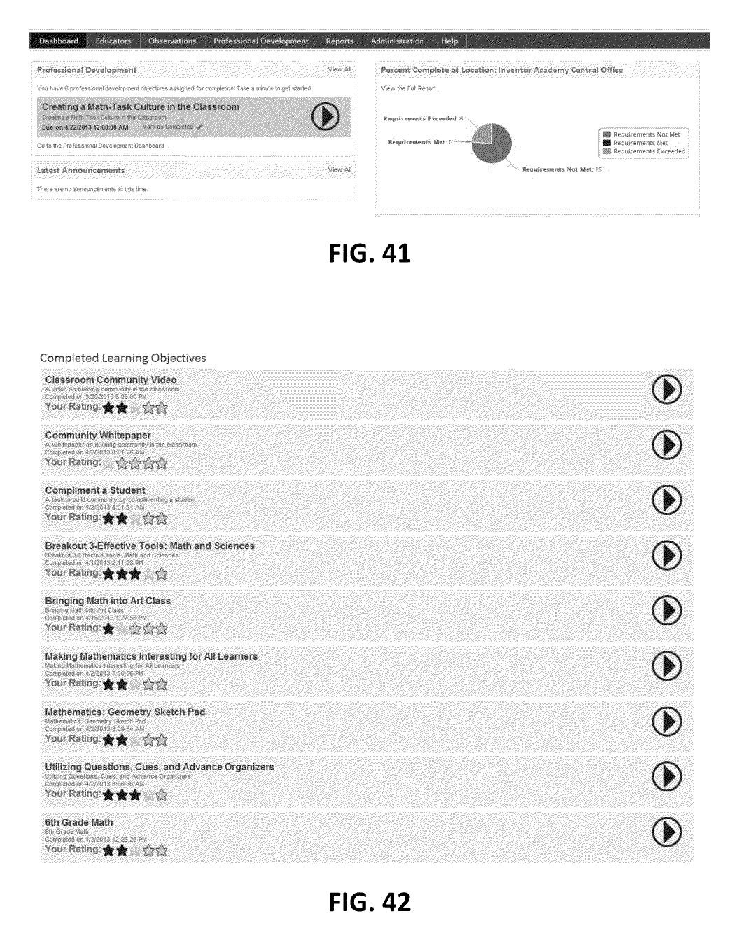

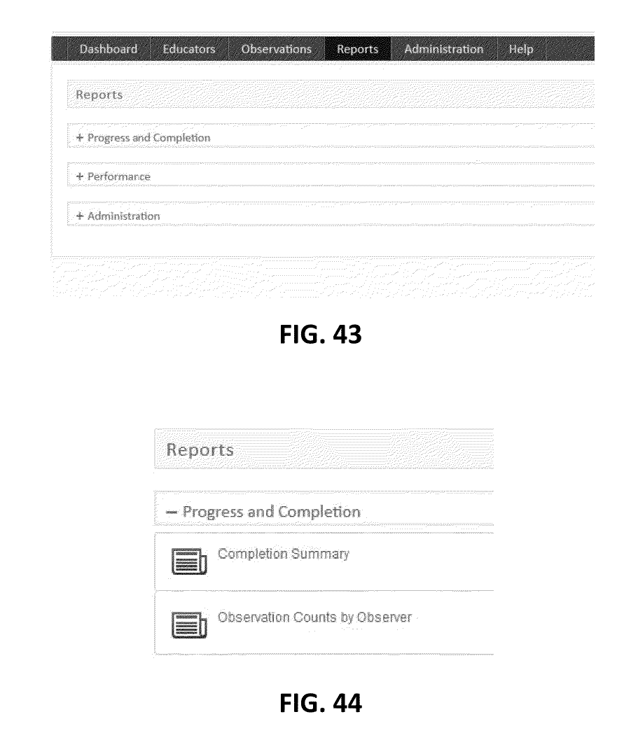

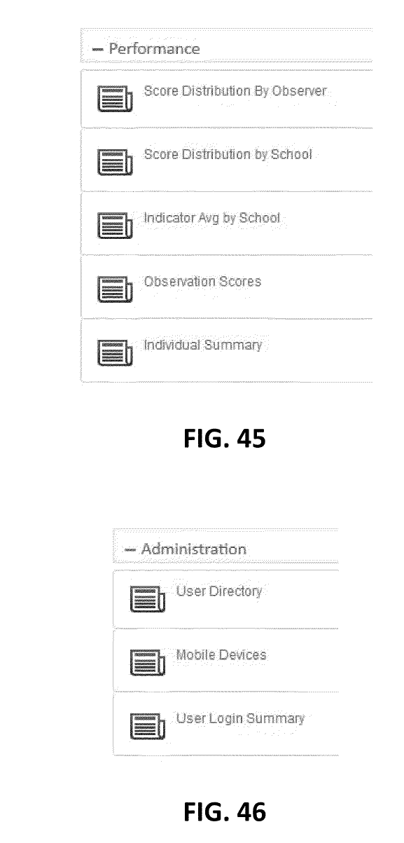

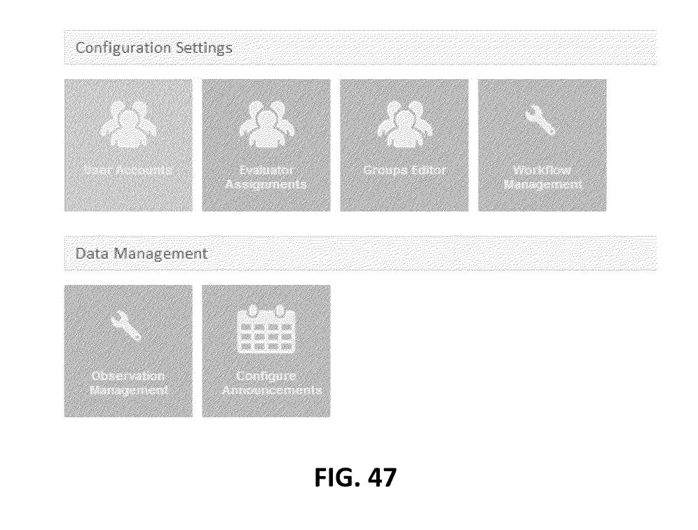

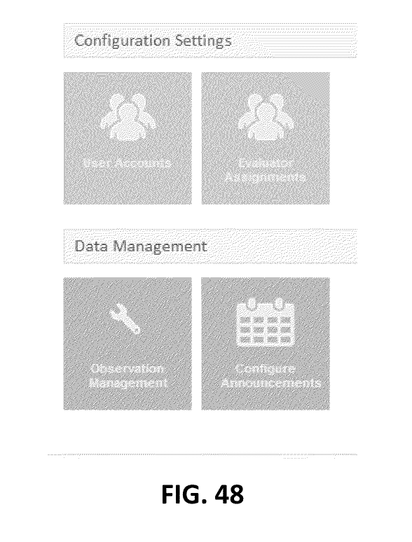

Preferably, a dedicated Professional Development (PD) tab is also presented to the user, along with the other tabs described elsewhere herein. For example, FIG. 40 depicts one embodiment of a PD tab reminding the educator of the PD courses (or training objectives) that are still required, along with any applicable deadlines for completion. Training statistics with a progress indicator may also be displayed to the user. Conveniently, a smaller version of the PD status may also be provided as a part of the Dashboard tab as shown in FIG. 41, along with any related progress indicators. This feature advantageously allows the user immediate notification of outstanding PD requirements upon login.

FIG. 42 shows the user completed PD courses, and includes a rating system which permits the educator to score the PD coursework in terms of its content, applicability, helpfulness and the like.

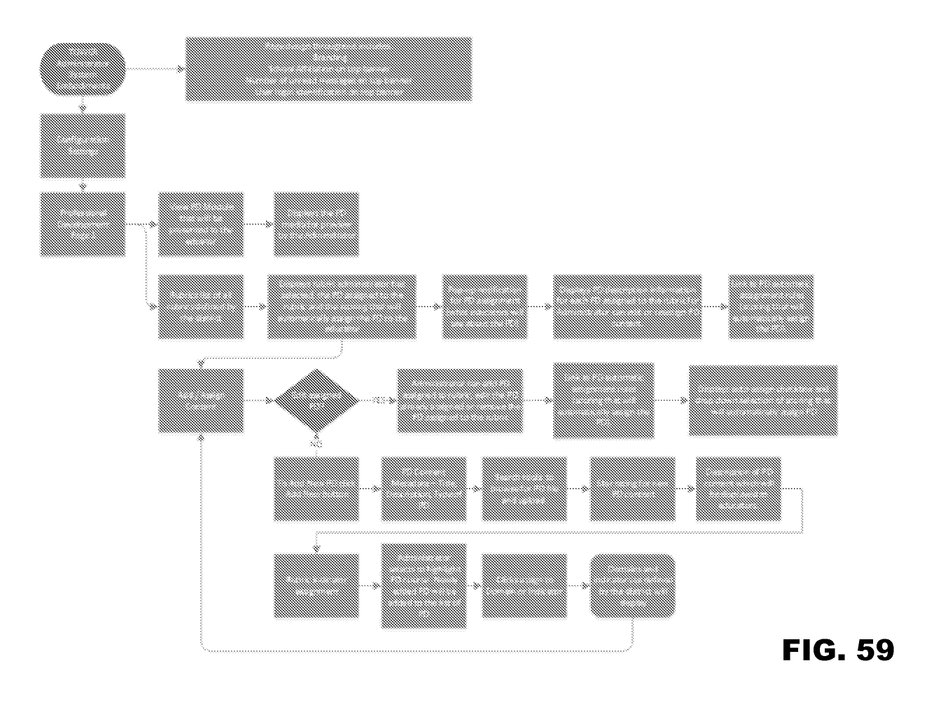

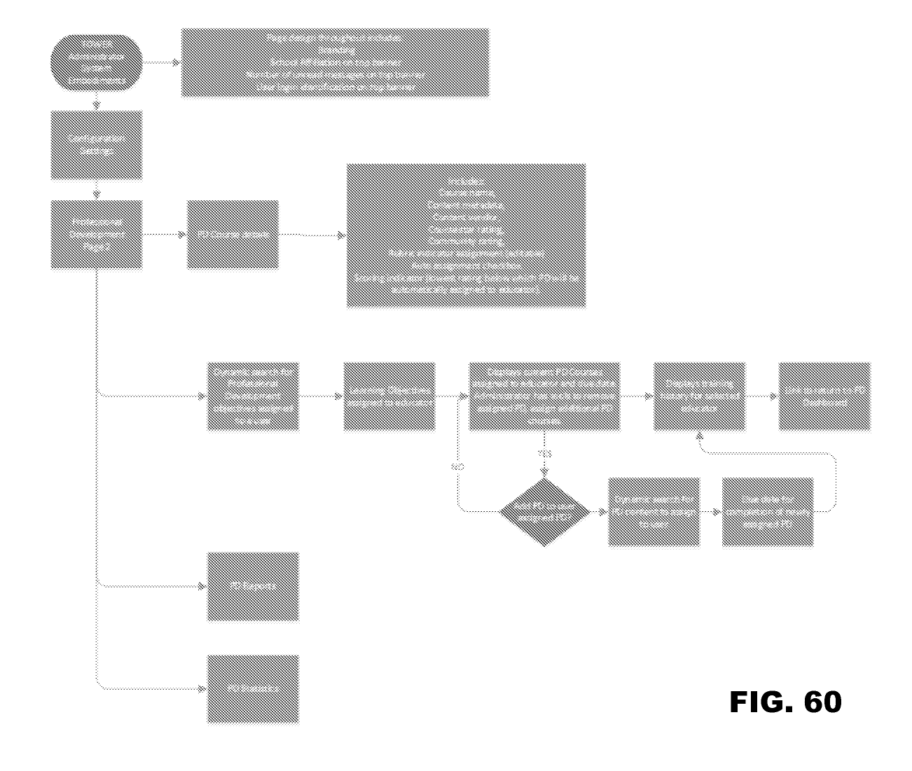

FIG. 59-60 illustrate the processes by which the PD elements of the TOWER system are managed. For example, the user can display all rubrics which were selected, any PD coursework assigned to the rubric, and the scoring that will automatically assign the PD to the educator, along with many other functions as shown in FIG. 59. PD reports, statistics, and management of PD details, can also be accessed and modified as shown in FIG. 60.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

The invention claimed is:

1. A teacher observation and evaluation system for mobile devices, comprising:
(a) a data server for storing and delivering selected information, including teacher data, rubrics, and other educational data;
(b) an administration server connected to the data server for controlling access by users;
(c) one or more wireless mobile devices connected to the data server via a wireless connection, wherein each mobile device includes one or more observation and evaluation rubrics; and
(e) wherein observation and evaluation data input onto the mobile device are synchronized to the data server.

2. The system of claim 1, wherein the rubrics are defined by a user who is a school administrator.

3. The system of claim 1, wherein an observation event scheduled on the administration server is transmitted to the mobile device.

4. The system of claim 1, wherein the users are granted differing access credentials to the system based on predetermined roles of observer, teacher, principal, and administration.

5. The system of claim 1, wherein the mobile device can record observation data without a wireless connection to the administration server.

6. The system of claim 1, wherein the mobile device enables the user to enter a plurality of scripting blocks related to the observation of a teacher.

7. The system of claim 1, wherein the rubric includes a plurality of indicators corresponding to performance criteria of the teacher.

8. The system of claim 1, wherein the rubric includes a plurality of indicators corresponding to performance criteria of the teacher, wherein the mobile device enables the user to enter a plurality of scripting blocks related to the observation of the teacher, and wherein the scripting blocks are mapped to one or more of the indicators by the user.

9. The system of claim 7, wherein the mobile device includes a display of the indicators, and means for scoring each of the indicators on a predetermined scale.

10. The system of claim 1, further including a professional development function, wherein predetermined professional development training is offered to a user based on the observation and evaluation data.

11. The system of claim 9, further including a professional development function, wherein predetermined professional development training is offered to a user based on the scoring of the indicators.

12. The system of claim 11, wherein the professional development training can be rated by the user.

13. The system of claim 10, wherein the scored indicators include a notification of a low score sufficient to trigger a predetermined professional development training requirement.

14. A teacher observation and evaluation method for mobile devices, comprising:
(a) providing a data server for storing and delivering selected information, including teacher data, rubrics, and other educational data;
(b) providing an administration server connected to the data server for controlling access by users;
(c) providing one or more wireless mobile devices connected to the data server via a wireless connection, wherein each mobile device includes one or more observation and evaluation rubrics;
(d) observing a teacher in a classroom setting and inputting into the mobile device observation and evaluation data related to the teacher's performance;
(e) synchronizing the observation and evaluation data with the data server; and
(f) reporting the observation and evaluation data to selected administrative personnel.

15. The method of claim 14, wherein the rubrics are defined by a user who is a school administrator.

16. The method of claim 14, wherein an observation event scheduled on the administration server is transmitted to the mobile device.

17. The method of claim 14, wherein the users are granted differing access credentials based on predetermined roles of observer, teacher, principal, and administration.

18. The method of claim 14, further comprising recording observation data on the mobile device without a wireless connection to the administration server.

19. The method of claim 14, further comprising entering a plurality of scripting blocks related to the observation of a teacher.

20. The method of claim 14, wherein the rubric includes a plurality of indicators corresponding to performance criteria of the teacher.

21. The method of claim 14, wherein the rubric includes a plurality of indicators corresponding to performance criteria of the teacher, wherein the mobile device enables the user to enter a plurality of scripting blocks related to the observation of the teacher, and further comprising mapping the scripting blocks to one or more of the indicators.

22. The method of claim 20, further comprising displaying the indicators to the user, and scoring each of the indicators on a predetermined scale.

23. The method of claim 14, further comprising offering predetermined professional development training in communication with the administration server to a teacher based on the observation and evaluation data.

24. The method of claim 22, further comprising offering predetermined professional development training in communication with the administration server to a teacher based on the scoring of the indicators.

25. The method of claim 24, further comprising rating the professional development training by the teacher.

26. The method of claim 22, further comprising notifying the user within the scored indicators of a low score sufficient to trigger a predetermined professional development training requirement.
